(19) United States
(12) Patent Application Publication
(10) Pub. No.: US 2003/0158945 A1
(43) Pub. Date: Aug. 21, 2003

(54) Single sign on computer system and method of use

(75) Inventor: Shu-Fan Liu, Hsin-Chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/079,747

(22) Filed: Feb. 19, 2002

(51) Int. Cl. G06F 15/16

(52) U.S. Cl. 709/227; 709/203

(57) ABSTRACT

The present invention is directed to a single sign on computer system and method that provides the ability for users of a large enterprise network to log-on only one time via a single authentication to obtain access to authorized resources. The system has a client device capable of communicating with a server network; a server network having an account collaboration agent server; at least one web server; at least one database server associated with the at least one web server, wherein the at least three web servers are in communication with each other and with the client device; and means for securely defining a user profile, wherein the user profile is capable of being retrieved by the account collaboration agent server. The invention is further directed to a method of use that includes the step of performing a handshaking algorithm to provide secure communications between the network servers.

### FIELD OF THE INVENTION

The present invention is directed to a single sign on computer system and method that provides the ability for users of large enterprise networks or customers to a web site to log-on only one time via a single authentication to obtain access to authorized resources.

### PRIOR ART

Prior art single sign on systems do not provide a for a secure and simple password management procedure for a client device to log into a large enterprise network having an enterprise portal interface. Typically such a network provides access to multiple application platforms, however, users often have to login again and again from one system to another system by using different passwords. For example, users may be required to submit different identification and passwords in order to login to e-mail applications and word processing applications.

This forces a user of such a network to remember many user identifications and associated passwords. If the user cannot successfully remember all the required passwords, then the user may be denied access to the entire system.

Often, HTTP protocol is used to encrypt passwords and then transmit them to access a system. Individual passwords are sent a help-desk which then queries the client device or network for user identification and passwords to determine authentication and authorization.

Cookie technology can be used to pass user id and passwords through session variables by first encoding the password before passing the password through the session variable. However, security may be violated even when passing passwords using HTTP protocol.

The present single sign on system and method can be used for accessing enterprise systems through an intranet or an extranet without using http to communicate passwords through the system; thereby, preventing any possible decoding of a user's password.

This single sign on system and method of the present invention reduces human duplicated key efforts that require entering multiple passwords. It can count the number of times a user visits whole web systems including legacy systems. Users can login only one time among different platforms and systems.

### SUMMARY OF THE INVENTION

It is an object of this invention to provide a single SSO method to prevent a user's password from being explored when submitting the password using http protocol and to protect a user's password from being cached or decoded.

It is an object of this invention to require no manpower to synchronize passwords among systems which allow a single sign on mechanism according to the present invention.

It is an object of this invention to provide a method for creating a log-in connection string, extracting the string and then leveraging the authentication process to allow for a user to have access to the system.

The present invention limits the number of passwords which a user is required to remember to gain access to a particular application or program. The single sign on method saves substantial amounts of time by allowing the user to initially log in once to the single sign on system. Then, by performing all subsequent log-ons to target web-based applications in the background using target programs, the multiple platform login process is performed in a manner transparent to the user.

In accordance therewith, the invention herein is directed to a single sign on computer system and method of use. In particular, in a first preferred embodiment according to this invention, there is provided a single sign on network comprising:

A. a client device capable of communicating with a server network;

B. a server network, the server network comprising:

an account collaboration agent server, the account collaboration agent server in communication with the client device;

at least one web server for accessing at least one associated target web-based application, the at least one web server having an associated time clock, and wherein the at least one web server is in communication with the account collaboration agent server;

at least one database server associated with the at least one web server, the at least one database server in communication with the at least one web-server and in further communication with the account collaboration agent server; and

C. means for securely defining a user profile, the user profile capable of being retrieved by the account collaboration agent server.

Further, and according to this invention, a method of using the single sign on system comprises the step of:

logging a user into the single sign on system;

building a secure connection string between the account collaboration agent server and the client device;

synchronizing the account collaboration agent server counter clock with the at least first and second time clocks associated with the at least two web servers;

defining the database schema;

securely logging into the at least first target web application;

securely logging onto the at least second target web application after first logging into the first target web application by performing a handshaking algorithm.

### BRIEF DESCRIPTION OF THE DRAWINGS

The various features, advantages, and other uses of the present invention will become more apparent by referring to the following detailed description and drawings in which:

FIG. 1 is an illustration of a single sign on system architecture according to a first preferred embodiment of the present invention;

FIG. 2 is an illustration of a single sign on system according to a first preferred embodiment of the present invention;

FIG. 3 is an illustration of the single sign on system architecture in accordance with a second preferred embodiment of the present invention;

FIG. 4 is an illustration of the single sign on system in accordance with a second preferred embodiment of the present invention;

FIG. 5 is a block diagram illustrating steps for using the single sign-on system;

FIG. 6 is a flowchart illustrating steps performed during a handshaking algorithm in accordance with the present invention;

### DESCRIPTION OF THE PREFERRED EMBODIMENT

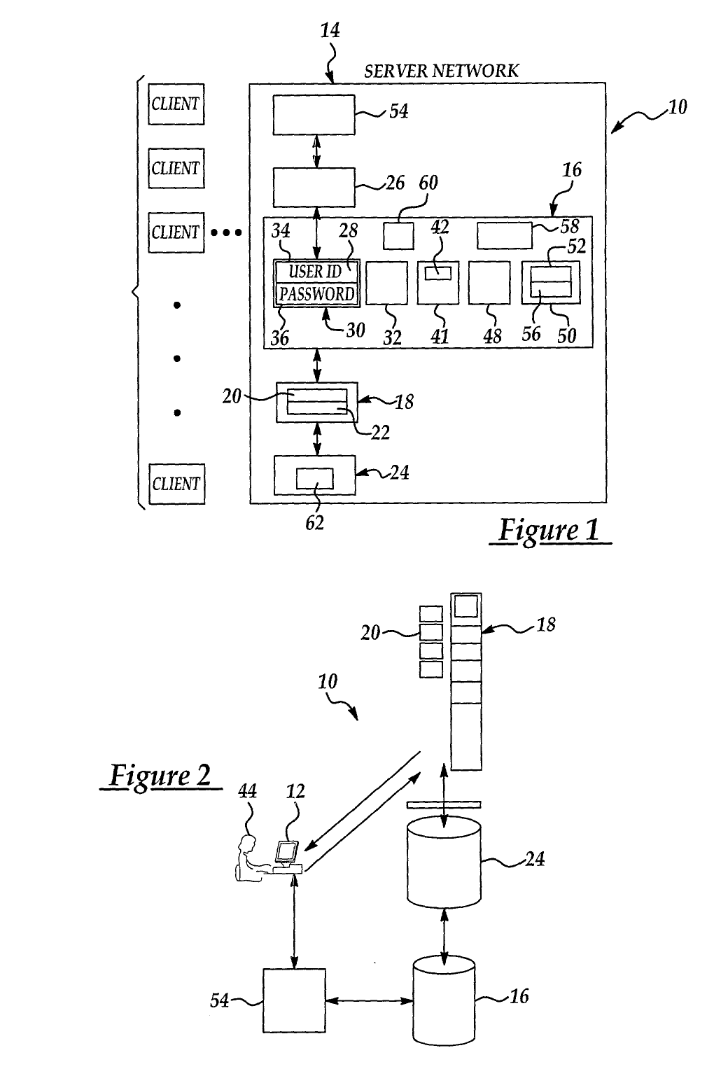

Referring now to the drawings, FIGS. 1-2 show a first preferred embodiment of a single sign on computer system 10 that allows for simple and secure access to a server network 40. The single sign on computer system 10 comprises at least one client device 12 capable of communicating with a server network 14. The server network 14 comprises an account collaboration agent server 16 in communication with the client device 12; at least one web server 18 for accessing at least one associated target web-based application 20; at least one database server 24 associated with the at least one web server 18; and means 26 for securely defining a user profile 28, the user profile 28 is capable of being retrieved by the account collaboration agent server 16.

As shown in FIGS. 1-2, the account collaboration agent server 16 further comprises memory means 30 for securely storing the user profile 28 there within, the user profile 28 comprises a user identification 34 and an associated user password 36; means (not shown)for securely retrieving 32 the user profile 28 from the memory means 30; means for building 26 a secure connection string between the client device 12 and the server network 14; means for timing 41 an amount of time X that a user 44 accesses the single sign on system 10; means for synchronizing 48 the means for timing 41 with the rest of the server network as described further below. Alternatively, the memory means 30 may be stored in a memory location not located on the account collaboration agent server.

The account collaboration agent further comprises at least one session variable index register 50 for indexing a user's session variables 52; means for defining a database schema 58. The means for timing 41 comprises a clock counter 42 that is initialized once the user profile 28 is retrieved from the user profile memory means 30. The initialized counter 42 then begins counting the time and continues throughout the user's 44 single sign on session. The counter 42 stops counting once the user 44, having the associated user profile 28, logs off of the single sign on system 10.

The session variables 52 may consist of the user identification 34 that has been authenticated and authorized by an authentication agent 54, and an associated timestamp 56 created when an authenticated and authorized user 44 requests access to the at least one web server target application 20. The timestamp 56 is an indicated time value extracted from the clock counter 42 and communicated to another server if there are any additional single sign on servers.

The means for defining a database schema 58 may consist of an account collaboration program 60 for executing control over the session variables to securely communicate the session variables from the account collaboration agent server to the at least one web-based server 18 when a user requests access to the at least one web-based server. The account collaboration program 60 preferably, is stored in the account collaboration server, however, the program 60 may be replicated and installed on the at least one web-based server 18. The program 60, when executed, provides secure communications between the account collaboration agent server 16, the at least one web server 18, and the associated at least one server database 24.

The at least one web server 18 has an associated time clock 22 capable of synchronizing with the account collaboration counter 42. Additionally, the at least one web server 18 is in communication with the account collaboration agent server 16 and is in further communication with the at least one database server 24.

The at least one database server 24 has a user identification index register 62 stored there within for indexing or storing the user identification 34.

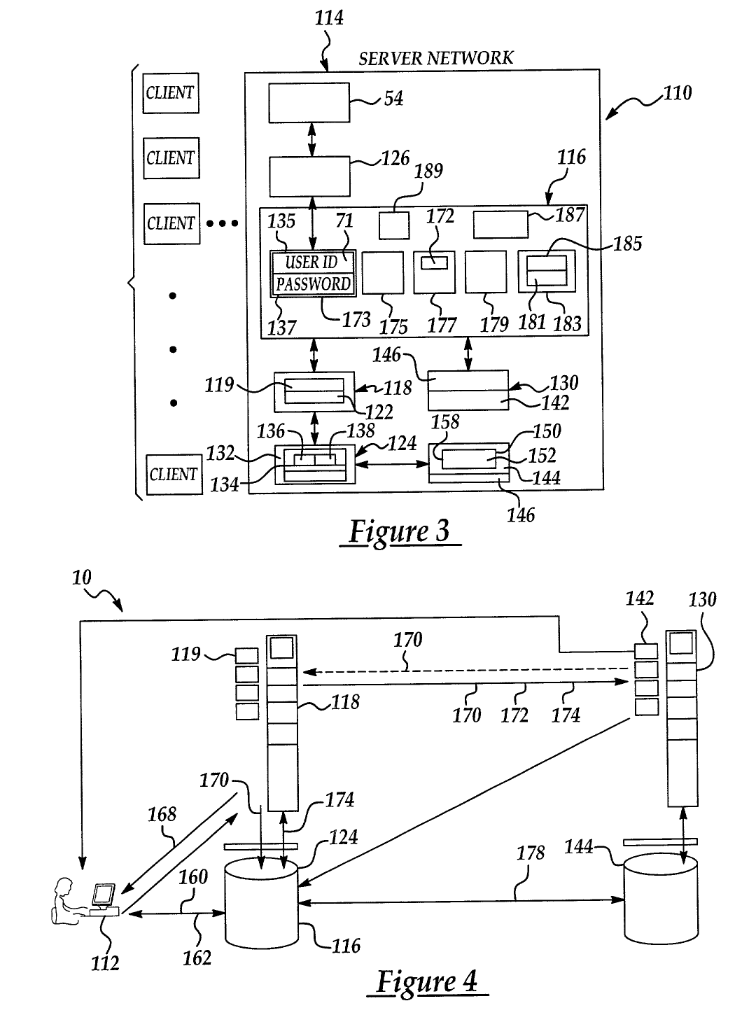

In a second preferred embodiment shown in FIGS. 3-4, a single sign-on computer system 110 comprises at least one client device 112 capable of communicating with a server network 114. The server network 114 comprises an account collaboration agent server 116 in communication with the client device 112; at least two web serves 118,130 in communication with each other and in further communication with the account collaboration agent server for accessing at least two respective associated target web-based applications; at least two database servers 124,144, each database server respectively associated with the at least two web servers 118,130; and means 136 for securely defining a user profile 71, the user profile 71 is capable of being retrieved by the account collaboration agent server 116.

As shown in FIGS. 3-4, the account collaboration agent server 116 further comprises memory means 173 for securely storing the user profile 71 there within, the user profile 71 comprises a user identification 135 and an associated user password 137; means for securely retrieving 175 the user profile 71 from the memory mens 173; means for building 126 a secure connection string between the client device 112 and the server network 114; means for timing 177 an amount of time X that a user 145 accesses the single sign on system 110; means for synchronizing 179 the means for timing 177 with the rest of the server network as described further below. Alternatively, the memory means 173 may be stored in a memory location not located on the account collaboration agent server 116.

The account collaboration agent server 116 further comprises at least one session variable index register 183 for indexing a user's session variables 185; means for defining a database schema 187.

The means for timing 177 comprises a clock counter 172 that is initialized once the user profile 71 is retrieved from the user profile memory means 173. The initialized counter 172 then begins counting the time and continues throughout the user's 145 single sign on session. The counter 172 stops counting once the user 145, having the associated user profile 71, logs off of the single sign on system 110.

The session variables 185 may consist of the user identification 135 that has been authenticated and authorized by an authentication agent 155, and an associated timestamp 181 created when an authenticated and authorized user 145 requests access to a web server target application. The timestamp 181 is an indicated time value extracted from the clock counter 172 and communicated to another server if there are any additional single sign on servers.

The means for defining a database schema 187 may consist of an account collaboration program 189 for executing control over the session variables to securely communicate the session variables from the account collaboration agent server to either one of the at least two web-based servers 118,130 when a user requests access to either one of the at least one web-based servers. The account collaboration program 189 preferably, is stored in the account collaboration server 116, however, the program 189 may be replicated and installed on the at least two web based servers 118,130. The program 189, when executed, provides secure communications between the account collaboration agent server 116, the at least two web servers 118,130 and their respective associated at least two server databases 124,144.

The single sign-on computer system 110 further comprises at least two web-servers, 118 and 130. The first web server 118 is the same as the web-based server 18 and has an associated first target application 119, and an associated database server 124 in communication with the at least one first web server 118, and wherein the at least one web server 118 has an associated first time clock 122; but is in further communication with the second web server 130. The at least first web server 118 and the at least second web server 130 are in further communication with the account collaboration agent server 116 that is capable of synchronizing with both the first and second web servers 118, and 130, respectively.

While only two web servers are shown in FIGS. 3-4, the system is capable of having a network consisting of up to Y web servers wherein each Y server is associated with a Y database. All web servers in such a system would be in communication with one another and are in further communication with the account collaboration agent 116.

The at least first associated database server 124 has a first web-server session variable index register 132 for indexing a users first web-server session variables 134, the first session variables comprise an authenticated and authorized user identification 158 and an associated first web-server timestamp 138. The associated first web-server timestamp 138 is an indicated first time variable extracted from the first web server time clock 122 when an authenticated and authorized user 140 requests access to the at least second web server target application 142.

Additionally, the second web server 130 can access at least a second associated target web-based application 142. The at least one second web server 130 has an associated second database server 144 in communication with the at least one second web server 130. Also, the at least one second web server 130 has an associated second time clock 146. The second web-database server 144 further comprises a second session variable index register 148 for indexing a users second web-server session variables 150. The second session variables 150 comprise an authenticated and authorized user identification 158 and an associated second web-server timestamp 152. The associated second web-server timestamp 152 is an indicated second time variable extracted from the second web server time clock 146 when an authenticated and authorized user requests access to the at least first web server target application.

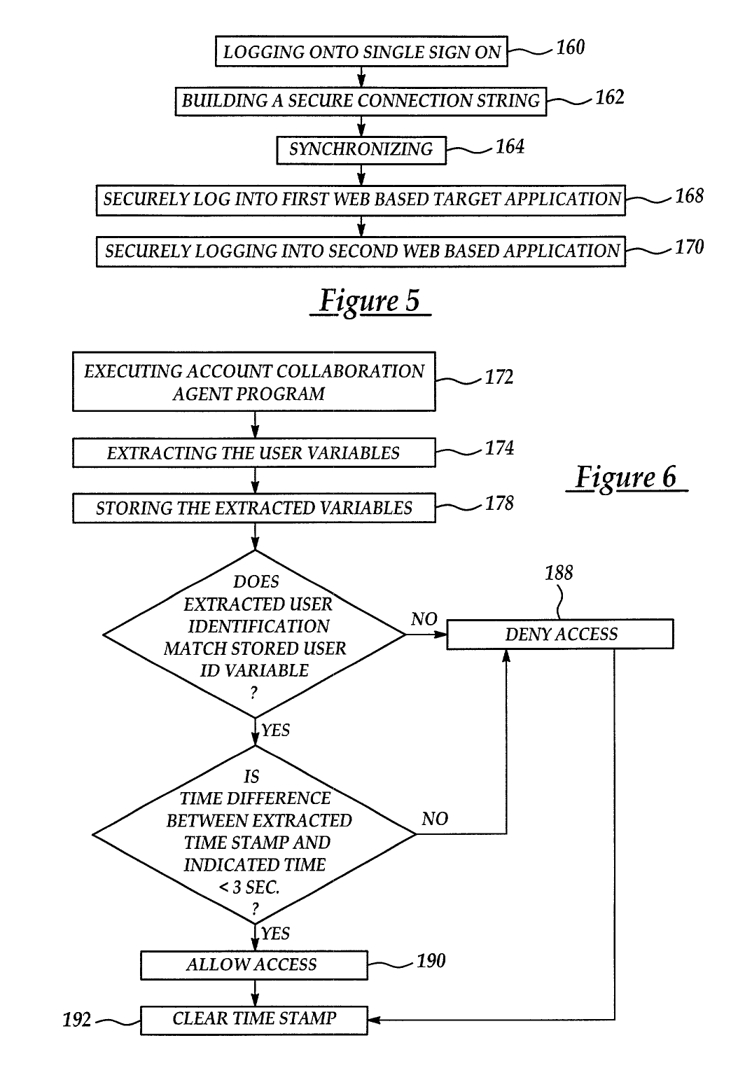

FIGS. 4-5 shows the method of using the single sign on network 10 wherein the single sign on network has at least two web based servers 118, 130 and associated target applications and databases as described above. The method of use generally includes the steps of: logging a user into the single sign on system 160; building a secure connection string between the account collaboration agent server and the client device 162; synchronizing an account collaboration agent server counter clock 172 with the at least first and second time clocks 122,146 associated with the at least two web servers 164; defining the database schema 166; securely logging into the at least first target web application 168; and securely logging onto the at least second target web application after first logging into the first target web application 170.

Additionally, FIGS. 4 and 6 shows a handshaking algorithm that is performed automatically upon execution of the account collaboration program. This algorithm is performed in a manner transparent to the user 44 such that the user only needs to enter the user profile once to initially log into the single sign on system. Preferably, as described above, the user profile consists of a password in combination with a user identification. The session variables may be securely communicated from one web server, the sending server S, to another web server, the receiving server R. For illustrative purposes, the first web server 118 will initially be the sending server and the second web server 130 will initially be the receiving server. Upon logging into the receiving web server, the user is automatically logged off of the sending web server.

The handshaking algorithm may be performed using the following steps: executing the account collaboration agent server program upon sending a log-on request from the at least first web server to the at least second web server 172; extracting the user identification and associated first timestamp from the at least first web server session variable index at the same time the sent log-on request to the second web server is sent 174; storing the extracted first web server variables within the second web database 178; comparing the received extracted user identification variable sent from the first web server with the user identification variable stored in the second web server session variable index 180; denying access to the second web server if the received extracted user identification does not match the stored second web server user identification variable 182; clearing the first web server time stamp from the first web server session variable index 184; comparing the extracted first web server timestamp with a time indicated on the second server time clock 186; denying access to the second web application if the extracted timestamp and the indicated time on the second server time clock is greater than n seconds 188; allowing access to the second web application if the extracted timestamp and the indicated time on the second server time clock is equal to or less than n seconds 190; and clearing extracted first web time stamp variable stored within the second web database 192. Preferably, n equals 3 seconds.

Similarly, the handshaking algorithm may be repeatedly performed between any two single sign on web based servers using the same steps as described in steps 172-192. For example, the initial receiving server, 130 may become the sending server and the same handshaking algorithm may be used to access web server 130. Then web server 130 becomes the new receiving server.

In a second preferred embodiment shown in FIGS. 3-4, a single sign-on computer system 110 comprises at least one client device 112 capable of communicating with a server network 114. The sever network 114 comprises an account collaboration agent server 116 in communication with the client device 112; at least two web servers 118, 130 in communication with each other and in further communication with the account collaboration agent server for accessing at least two respective associated target web-based applications; at least two database servers 124, 144, each database server respectively associated with the at least two web servers 118, 130; and means 136 for securely defining a user profile 71, the user profile 71 is capable of being retrieved by the account collaboration agent server 116.

As shown in FIGS. 3-4, the account collaboration agent server 116 further comprises memory means 173 for securely storing the user profile 71 therewithin, the user profile 71 comprises a user identification 135 and an associated user password 137; means for securely retrieving 175 the user profile 71 from the memory means 173; means for building 126 a secure connection string between the client device 112 and the server network 114; means for timing 177 an amount of time X that a user 145 accesses the single sign on system 110; means for synchronizing 179 the means for timing 177 with the rest of the server network as described further below. Alternatively, the memory means 173 may be stored in a memory location not located on the account collaboration agent server 116.

The account collaboration agent server 116 further comprises at least one session variable index register 183 for indexing a user's session variables 185; means for defining a database schema 187.

The means for timing 177 comprises a clock counter 172 that is initialized once the user profile 71 is retrieved from the user profile memory means 173. The initialized counter 172 then begins counting the time and continues throughout the user's 145 single sign on session. The counter 172 stops counting once the user 145, having the associated user profile 71, logs off of the single sign on system 110.

The session variables 185 may consist of the user identification 135 that has been authenticated and authorized by an authentication agent 155, and an associated timestamp 181 created when an authenticated and authorized user 145 requests access to a web server target application. The timestamp 181 is an indicated time value extracted from the clock counter 172 and communicated to another server if there are any additional single sign on servers.

The means for defining a database schema 187 may consist of an account collaboration program 189 for executing control over the session variables to securely communicate the session variables from the account collaboration agent server to either one of the at least two web-based servers 118, 130 when a user requests access to either one of the at least one web-based servers. The account collaboration program 189 preferably, is stored in the account collaboration server 116, however, the program 189 may be replicated and installed on the at least two web based servers 118, 130. The program 189, when executed, provides secure communications between the account collaboration agent server 116, the at least two web servers 118, 130 and their respective associated at least two server databases 124, 144.

Although various embodiments of the invention have been disclosed for illustrative purposes, it is understood that variations and modifications can be made by one skilled in the art without departing from the spirit of the invention.

What is claimed is:

1. A single sign-on computer system comprising:
(a) a client device capable of communicating with a server network;
(b) a server network, the server network comprising:
an account collaboration agent server, the account collaboration agent server in communication with the client device;
at least one web server for accessing at least one associated target web-based application, the at least one web server having an associated time clock, and wherein the at least one web server is in communication with the account collaboration agent server;
at least one database server associated with the at least one web server, the at least one database server in communication with the at least one web-server and in further communication with the account collaboration agent server; and
(c) means for securely defining a user profile, the user profile capable of being retrieved by the account collaboration agent server.

2. The single sign on system of claim 1 wherein the account collaboration agent server further comprises memory means for securely storing the user profile there within.

3. The single sign on system of claim 1 wherein the account collaboration agent server further comprises:
(a) means for securely retrieving the user profile from the memory means, wherein the user profile comprises a user identification and an associated user password;
(b) means for building a secure connection string between the client device and the server network;
(c) means for timing an amount of time a user accesses the single sign on system, the means for timing comprises a clock counter, and wherein the clock counter initializes and begins counting the time once the user profile is retrieved from the user profile memory means, and stops counting once a user having the associated user profile logs off of the single sign on system;
(d) means for synchronizing the clock counter with the at least one web server time clock;
(e) at least one session variable index register for indexing a user's session variables, the session variables comprise an authenticated and authorized user identification and a timestamp associated with the user identification, the timestamp is an indicated time value extracted from the clock counter when an authenticated and authorized user requests access to the at least one web server target application; and
(f) means for defining a database schema, wherein the schema allows secure communications between the account collaboration agent server, the at least one web server, and the associated at least one server database.

4. The single sign on system of claim 3 wherein the means for defining a database schema further comprises an account collaboration program for executing control over the session variables to securely communicate the session variables from the account collaboration agent server to the at least one web-based server when a user requests access to the at least one web-based server.

5. The single sign on of claim 4 wherein the an account collaboration program is replicated in the at least one web server.

6. The single sign on of claim 3 wherein the at least one database has a user identification index register stored within for indexing the user identification.

7. A single sign-on computer system comprising:
(a) a client device capable of communicating with a server network;
(b) a server network, the server network comprising:
at least a first web server for accessing at least one first associated target web-based application, the at least first web server having an associated first database server in communication with the at least one first web server, and wherein the at least one web server has an associated first time clock,
at least a second web server for accessing at least one second associated target web-based application, the at least one second web server having an associated second database server in communication with the at least one second web server, and wherein the at least one web server has an associated second time clock,
an account collaboration agent server in communication with the client device, the first web server, and the second web server, the account collaboration agent server comprises:
means for securely retrieving a user profile, wherein the user profile comprises a user identification and an associated user password,
means for building a secure connection string between the client device and the server network,
means for timing an amount of time a user accesses the single sign on system, the means for timing comprises a clock counter, and wherein the clock counter initializes and begins counting the time once the user profile is accessed, and stops counting once a user having the associated user profile logs off of the single sign on system,
means for synchronizing the clock counter with the at least two web servers time clocks;
at least one session variable index register for indexing a user's session variables, the session variables comprise an authenticated and authorized user identification and an initial timestamp associated with the user identification, the initial timestamp is an indicated time value extracted from the clock counter when an authenticated and authorized user requests access to the at least one web server target application, and
means for defining a database schema, wherein the schema allows secure communications between the account collaboration agent server, the at least two web servers, and their associated at least two server databases; and
(c) means for defining a user profile, the user profile capable of being retrieved by the account collaboration agent server.

8. The single sign on system of claim 7 wherein the account collaboration agent server further comprises memory means for securely storing the user profile there within.

9. The single sign on system of claim 8 wherein the means for defining a database schema further comprises an account collaboration program for executing control over the session variables to securely communicate the session variables from the account collaboration agent server to the at least one web-based server when a user requests access to the at least one web-based server.

10. The single sign on of claim 9 wherein the an account collaboration program is replicated in the at least two web servers.

11. The single sign on of claim 9 wherein the at least first associated database has a first web-server session variable index register for indexing a users first web-server session variables, the first session variables comprise an authenticated and authorized user identification and an associated first web-server timestamp, the associated first web-server timestamp is an indicated first time variable extracted from the first web server time clock when an authenticated and authorized user requests access to the at least second web server target application.

12. The single sign on of claim 9 wherein the at least second associated database has a second web-server session variable index register for indexing a users second web-server session variables, the second session variables comprise an authenticated and authorized user identification and an associated second web-server timestamp, the associated second web-server timestamp is an indicated second time variable extracted from the second web server time clock when an authenticated and authorized user requests access to the at least first web server target application.

13. A method of using the single sign on system of claim 11 comprising the steps of logging a user into the single sign on system; building a secure connection string between the account collaboration agent server and the client device; synchronizing the account collaboration agent server counter clock with the at least first and second time clocks associated with the at least two web servers; defining the database schema; securely logging into the at least first target web application; securely logging onto the at least second target web application after first logging into the first target web application.

14. The method of claim 13 wherein the step of securely logging into the second target application further comprises executing the account collaboration agent server program upon sending a log-on request from the at least first web server to the at least second web server; extracting the user identification and associated first timestamp from the at least first web server session variable index at the same time the sent log-on request to the second web server is sent; storing the extracted first web server variables within the second web database; comparing the received extracted user identification variable sent from the first web server with the user identification variable stored in the second web server session variable index; denying access to the second web server if the received extracted user identification does not match the stored second web server user identification variable; clearing the first web server time stamp from the first web server session variable index; comparing the extracted first web server timestamp with a time indicated on the second server time clock; denying access to the second web application if the extracted timestamp and the indicated time on the second server time clock is greater than n seconds; allowing access to the second web application if the extracted timestamp and the indicated time on the second server time clock is equal to or less than n seconds; and clearing extracted first web time stamp variable stored within the second web database.

15. The method of claim 14 wherein n equals three seconds.

16. The method of claim 15 wherein the step of securely logging into the first target application further comprises: executing the account collaboration agent server program upon sending a log-on request from the at least second web server to the at least first web server; extracting the user identification and associated second timestamp from the at least second web server session variable index at the same time the sent log-on request to the first web server is sent; storing the extracted second web server variables within the first web database; comparing the received extracted user identification variable sent from the second web server with the user identification variable stored in the first web server session variable index; denying access to the first web server if the received extracted user identification does not match the stored first web server user identification variable; clearing the second web server time stamp from the second web server session variable index; comparing the extracted second web server timestamp with a time indicated on the first server time clock; denying access to the first web application if the extracted timestamp and the indicated time on the first server time clock is greater than n seconds; allowing access to the first web application if the extracted timestamp and the indicated time on the first server time clock is equal to or less than n seconds; and clearing extracted second web time stamp variable stored within the first web database.

17. The method of claim 16 wherein n equals three seconds.
